(19) United States
(12) Patent Application Publication
(10) Pub. No.: US 2024/0161605 A1
(43) Pub. Date: May 16, 2024

(54) APPARATUS FOR CALCULATING SAFETY OPERATION INDEX, AND METHOD USING THE SAME

(71) Applicants: Hyundai Motor Company, Seoul (KR); Kia Corporation, Seoul (KR)

(72) Inventor: Seungwoo Ha, Seoul (KR)

(73) Assignees: Hyundai Motor Company, Seoul (KR); Kia Corporation, Seoul (KR)

(21) Appl. No.: 18/233,569

(22) Filed: Aug. 14, 2023

(30) Foreign Application Priority Data
Nov. 15, 2022 (KR) 10-2022-0152805

(51) Int. Cl. G08G 1/01

(52) U.S. Cl. CPC G08G 1/0125; G08G 1/0112

(57) ABSTRACT

A safety operation index calculation device and a method are disclosed. An apparatus may in close one or more processors and memory. The memory may store instructions that, when executed by the one or more processors, cause the apparatus to extract, from driving data collected for drivers whose safety operation indexes are higher than a threshold value, driving data that may be determined as dangerous driving; classify, based on predetermined criteria, the extracted driving data into a plurality of groups; designate a group, of the plurality of groups, having a size larger than remaining groups of the plurality of groups, as a defensive driving group; and update the safety operation indexes for the drivers based on at least a portion, of the extracted driving data, corresponding to the remaining group.

### CROSS-REFERENCE TO RELATED APPLICATION

The present application claims priority to and the benefit of Korean Patent Application No. 10-2022-0152805, filed on Nov. 15, 2022, the disclosure of which is incorporated by reference in its entirety.

### TECHNICAL FIELD

The present disclosure relates to an apparatus for calculating a safety operation index and a method thereof.

### BACKGROUND

Usage-based insurance (UBI) reflects the driver's driving information when calculating possible insurance premium discounts. While vehicle insurance, in general, takes into account the driver's demographic information (age, gender, accident history, etc.) to calculate the premium, UBI additionally uses driving information such as mileage and driving time to calculate the premium.

Additionally, behavior-based insurance (BBI) reflects the driver's driving habits such as acceleration, deceleration, sharp lane changes, and speeding when calculating premium discounts.

BBI is becoming increasingly available as the number of connected car service vehicles increases.

UBI may be used as an umbrella term to refer to both UBI and BBI. The UBI score may a safety operation index, and the safety operation index may be adjusted upward or downward depending on the driver's driving habits.

The safety operation index is utilized as a driver's safe driving indicator. For example, if the driver shows driving habits such as sudden acceleration, sudden deceleration, sudden stop, and sudden turn due to incorrect driving habits, the safety operation index may be adjusted downward.

However, even if a driver with a high safety operation index is driving defensively most of the time, if the driver needs to perform an evasive maneuver due to a dangerous driving behavior of another vehicle, the driver's safety operation index may be classified as dangerous driving and the driver's safety operation index may be adjusted downward.

In addition, even if the driver is not at fault for an actual accident, he or she may be classified as a risky driver.

As such, it can be difficult to reflect the driver's driving intentions in the calculation of the safety operation index using only conventional numerical driving data, and it can be difficult to improve the accuracy and reliability of the safety operation index accordingly.

### SUMMARY

The present disclosure provides a safety operation index calculator and a method for calculating a safety operation index that reflects a driver's driving intention.

According to one or more example embodiments of the present disclosure, an apparatus may include one or more processors and memory. The memory may store instructions that, when executed by the one or more processors, cause the apparatus to: extract, from driving data collected for drivers whose safety operation indexes are higher than a threshold value, driving data that is determined as dangerous driving; classify, based on predetermined criteria, the extracted driving data into a plurality of groups; designate a group, of the plurality of groups, having a size larger than remaining groups of the plurality of groups, as a defensive driving group; and update the safety operation indexes for the drivers based on at least a portion, of the extracted driving data, corresponding to the remaining groups.

The extracted driving data may include at least one of a vehicle speed, a steering angle, a yaw rate, a distance from a leading vehicle, a lane change signal, a road type, a driving time zone, an acceleration, a sudden acceleration, a sudden deceleration, a sudden stop, or a sudden lane change.

To classify the extracted driving data, the instructions, when executed by the one or more processors, may cause the apparatus to: convert each data point of the extracted driving data to coordinate values; and create each group, of the plurality of groups, by selecting at least a predetermined minimum number of data points, of the extracted driving data, having coordinate values within a threshold distance away from each other.

The instructions, when executed by the one or more processors, may further cause the apparatus to designate the remaining groups, other than the defensive driving group, as a dangerous driving group.

The instructions, when executed by the one or more processors, may further cause the apparatus to adjust the threshold value based on at least a second portion, of the extracted driving data, corresponding to the defensive driving group.

The instructions, when executed by the one or more processors, may further cause the apparatus to: compare a first distribution of the safety operation indexes of the drivers with a second distribution of motor vehicle insurance accident compensation data; and adjust, based on a result of the comparison of the first distribution with the second distribution, at least one of the threshold distance or the predetermined minimum number of data points such that the first distribution is similar, within a predetermined range, to the second distribution.

According to one or more embodiments of the present disclosure, a method may include: extracting, by an apparatus and from driving data collected for drivers whose safety operation indexes are higher than a threshold value, driving data that is determined as dangerous driving; classifying, based on predetermined criteria, the extracted driving data into a plurality of groups; designating a group, of the plurality of groups, having a size larger than remaining groups of the plurality of groups, as a defensive driving group; and updating the safety operation indexes for the drivers based on at least a portion, of the extracted driving data, corresponding to the remaining groups.

The extracted driving data may include at least one of a vehicle speed, a steering angle, a yaw rate, a distance from a leading vehicle, a lane change signal, a road type, a driving time zone, an acceleration, a sudden acceleration, a sudden deceleration, a sudden stop, or a sudden lane change.

Classifying may include: converting each data point of the extracted driving data to coordinate values; and creating each group, of the plurality of groups, by selecting at least a predetermined minimum number of data points, of the extracted driving data, having coordinate values within a threshold distance away from each other.

The method may further include designating the remaining groups, other than the defensive driving group, as a dangerous driving group.

The method may further include adjusting the threshold value based on at least a second portion, of the extracted driving data, corresponding to the defensive driving group.

The method may further include adjusting, based on the at least second portion of the extracted driving data conforming to a normal distribution, the threshold value.

The method may further include adjusting, based on the at least second portion of the extracted driving data, the threshold value using a machine learning algorithm.

The method may further include: comparing a first distribution of the safety operation indexes of the drivers with a second distribution of motor vehicle insurance accident compensation data; and adjusting, based on a results of the comparison of the first distribution with the second distribution, at least one of the threshold distance or the predetermined minimum number of data points such that the first distribution is similar, within a predetermined range, to the second distribution.

The effects of the one or more example embodiments of the present disclosure are not limited to those mentioned above, and other effects not mentioned will be apparent to those skilled in the art from the description of the claims.

### DRAWINGS

FIG. 1 shows a block diagram of a safety operation index calculator.

FIG. 2 shows the process of representing driving data that may be judged as dangerous driving by the safety operation index calculation apparatus shown in FIG. 1 as data with coordinate values, and grouping the data into a plurality of groups.

FIGS. 3 and 4 shows a process of calibrating a distribution map of a safety operation index calculated through the process of FIG. 2 by comparing it with a distribution map of a vehicle insurance accident compensation amount data.

FIG. 5 shows a flowchart illustrating a method of calculating a safety operation index using the safety operation index calculation device shown in FIG. 1.

### DETAILED DESCRIPTION

Throughout the specification, like reference numerals refer to like components. This specification does not describe all elements of the embodiments, and omits what is common in the art to which the present embodiment belongs or what is redundant between embodiments.

Throughout the specification, when a part is to be “connected” to another part, this includes direct connections as well as indirect connections, and indirect connections include connections via a wireless communication network.

In addition, when a part is to “include” a component, it is meant to be capable of including additional components, not to exclude other components, unless specifically stated to the contrary.

Singular expressions include plural expressions, unless the context clearly indicates otherwise.

In addition, terms such as “part,” “device,” “block,” “member,” “module,” and the like may refer to a unit that handles at least one function or behavior. For example, these terms may refer to at least one piece of hardware, such as a field-programmable gate array (FPGA)/application specific integrated circuit (ASIC), at least one piece of software stored in memory, or at least one process handled by a processor.

The designations given to the steps are used to identify the steps and are not intended to indicate the order of the steps with respect to each other, and the steps may be performed in any order other than that specified unless the context clearly indicates a particular order.

Hereinafter, one or more example embodiments of the present disclosure will be described with reference to the accompanying drawings.

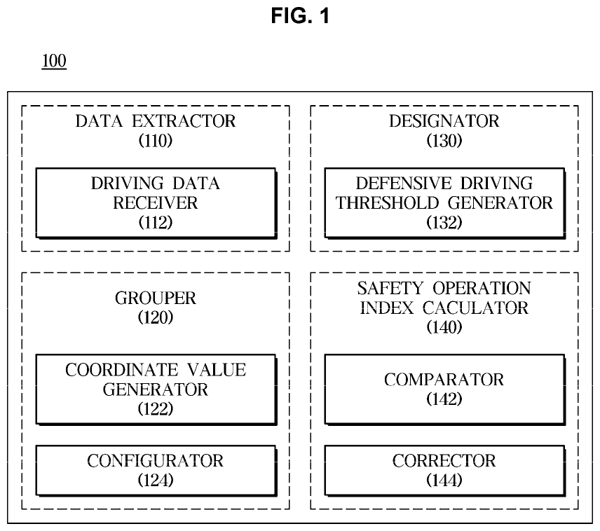

FIG. 1 shows a block diagram of a safety operation index calculation device.

The safety operation index (also referred to as safety operation score) may be defined as a driver's driving habit score calculated based on driving data including driving habits (speeding, sudden deceleration, sudden acceleration, etc.), driving environment (road type, driving time, etc.), and may be used in insurance premium discount services such as UBI (Usage-Based Insurance) and BBI (Behavior-Based Insurance). Sudden acceleration may correspond to a positive acceleration value that is above (e.g., a rate at which speed increases is higher than) a threshold acceleration value. Sudden deceleration may correspond to a negative acceleration value that is below (e.g., a rate at which speed decreases is higher than) a threshold deceleration value.

Drivers (e.g., high scorers) with higher scores (e.g., indexes) than the baseline are more likely to drive safely and defensively on a daily basis due to good driving habits than other drivers. As a result, it can be assumed that they receive a larger discount on their insurance premiums than other drivers.

Therefore, it is necessary to consider aspects in the driving data of high scorers of the safety operation index that may appear as dangerous driving in the driving data, even though they actually performed defensive driving in unavoidable situations, when calculating the safety operation index.

Considering this situation, the safety operation index calculation device 100 enables a safety operation index reflecting the driver's driving intention to be calculated.

Referring to FIG. 1, the safety operation index calculator 100 includes a data extractor 110 that extracts driving data that may be determined as dangerous driving from the driving data collected for each driver whose safety operation index is higher than the threshold based on a preset value, and a grouper 120 that groups the extracted driving data into a plurality of groups based on the preset value, a designator 130 that designates a group of the plurality of groups with a relatively large size compared to the other groups as defensive driving, and a safety operation index calculator 140 that calculates a safety operation index for each driver based on the driving data of the remaining groups excluding the group designated as defensive driving.

The safety operation index calculator 100 may be included in a fleet management server providing a connected car service. The fleet management server may store driver information, vehicle information, and various settings of in-vehicle equipment for each driver account.

The data extractor 110 described above includes a driving data receiver 112 that receives driving data including one or more of a vehicle speed, a steering angle, a yaw rate, a distance from a vehicle in front, a lane change signal, a road type, a driving time zone, an acceleration, a sudden acceleration, a sudden deceleration, a sudden stop, and a sudden lane change from a vehicle for each driver, and the driving data received by the driving data receiver 112 that exceeds or falls short of a preset value may be extracted as driving data that may be determined as dangerous driving.

The grouper 120 includes a coordinate value generator 122 that represents the extracted driving data as data with coordinate values, a radius that represents a distance between the data, and a configurator 124 that sets a minimum number of data that should exist within the radius, and when the minimum number of data exists within the radius centered on each data, the data within the radius may be grouped into one group.

The designator 130 may designate a group with a relatively large number of data in the radius among the plurality of groups as a defensive operation, and the remaining groups except for the group designated as a defensive operation as a dangerous operation.

The designator 130 may include a defensive driving threshold generator 132 that derives a threshold that may be classified as defensive driving based on the driving data of the group designated as defensive driving.

The safety operation index calculator 140 may include a comparator 142 that compares the distribution of the safety operation index by driver with the distribution of the vehicle insurance accident compensation amount data, and a corrector 144 that, based on the comparison result, changes one or more values of the radius and the minimum number of data so that the distribution of the safety operation index is similar to the distribution of the vehicle insurance accident compensation amount data within a set range, so that the range designated as defensive driving is adjusted.

Hereinafter, each component of the safety operation index calculator 100 will be described in detail.

The data extractor 110 extracts driving data that may be determined as dangerous driving from the driving data collected for each driver whose safety operation index is higher than the threshold based on a preset value.

At this time, the driving data receiver 112 receives driving data including one or more of vehicle speed, steering angle, yaw rate, distance to the vehicle in front, lane change signal, road type, driving area, driving time, acceleration, sudden acceleration, sudden deceleration, sudden stop, and sudden lane change from the vehicle of each driver. Such driving data may be measured by a camera mounted on the vehicle, LiDAR, RADAR, acceleration sensor, speed sensor, GPS sensor, angular velocity sensor, or the like.

The grouper 120 groups the driving data extracted by the data extractor 110 into a plurality of groups according to the set criteria.

For this purpose, the coordinate value generator 122 represents the driving data extracted by the data extractor 110 as data with coordinate values.

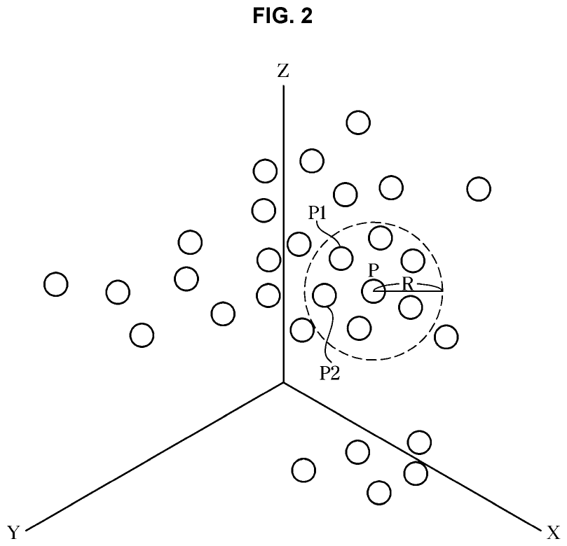

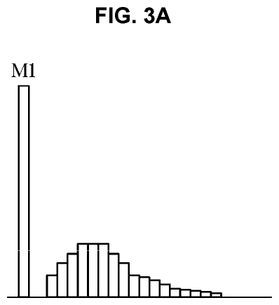

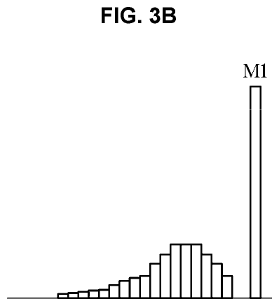

FIG. 2 shows the process of representing driving data that may be determined as dangerous driving by the safety operation index calculation apparatus shown in FIG. 1 as data with coordinate values, and grouping the data into a plurality of groups.

Referring to FIG. 2, the driving data extracted by the data extractor 110 on the XYZ axes may be displayed as data points with coordinate values.

For example, the X axis, the Y axis, and the Z axis are set to a vehicle speed, a steering angle, and a yaw rate, respectively, and the driving data that may be determined (e.g., categorized) as dangerous driving as described above may be distributed as data with XYZ coordinate values on the XYZ axes. At this time, the XYZ axes may be set to other elements of the driving data (e.g., sudden acceleration, sudden deceleration, etc.).

TABLE 1

| | | | | | Sudden | Sharp |
|---|---|---|---|---|---|---|
| Time | | Steering | . . . (omit- | Acceler- | acceler- | deceler- |
| (seconds) | Slow | Angle | ted) . . . | ation | ation | ation |
| 1 | 0 | 0 | | 0 | 0 | 0 |
| 2 | 5 | 10 | | 5 | 0 | 0 |
| 3 | 10 | 0 | | 5 | 0 | 0 |
| 4 | 12 | 0 | | 2 | 0 | 0 |
| 5 | 13 | 0 | | 1 | 0 | 0 |
| 6 | 15 | 0 | | 2 | 0 | 0 |
| 7 | 16 | 1 | | 1 | 0 | 0 |
| 8 | 30 | 3 | | 14 | 1 | 0 |
| 9 | 18 | 240 | | −12 | 0 | 1 |
| . . . (omit- | | | | . . . | . . . | . . . |
| ted) . . . | | | | | | |
| Total counts | | | | | 10 | 5 |

Table 1 shows an example of driving data collected every second for a driver whose safety operation index is higher than the threshold. If the preset value of acceleration that may be determined as dangerous driving is more than 10 kps/hs or less than −10 kps/hs, the acceleration at 8 and 9 seconds corresponds to the values of 14 and −12, respectively, and is classified as dangerous driving of sudden acceleration and sudden deceleration, and the total number of times represents 10 instances of sudden acceleration and 5 instances of sudden deceleration. The driving data that may be determined as dangerous driving of these drivers may be displayed as data (points) with coordinate values on the XYZ axes, and may be performed for each driver.

The configurator 124 sets a radius indicating a distance between each data point having a coordinate value and a minimum number of data points that should exist within the radius. For example, the distance between data points may be set to a radius R, and the minimum number of data points that must be present within that R radius may be set to 5. These radius and minimum number of data points are parameter values, which may be used to group the data points by the grouper 120, which will be described later.

The grouper 120 may group the data points into one group, for example, centering on the data point P, since the minimum number of data points within the radius R is 5 or more, according to the setting of the configurator 124. This process may be performed for all data points located as coordinate values on the XYZ axes, such as data points P1, P2, etc.

The grouper 120 may perform the above-described parameter (R, 5) setting and grouping process using, for example, the density-based algorithm “DBSMAY”, which is based on the assumption that data belonging to the same group are distributed close to each other.

The designator 130 designates a group with a relatively large number of data within the above-described radius among the plurality of groups grouped by the grouper 120 as a defensive driving group, and the remaining groups, other than the defensive driving group, may be designated as a dangerous driving group (e.g., a high-risk group).

In other words, under the statistical assumption that a high-scoring driver whose safety operation index is higher than the threshold generally performs mostly defensive driving, a group with a relatively large number of data within the set radius among the plurality of groups grouped by the grouper 120 is designated as defensive driving, so that a safety operation index reflecting the driver's driving intention may be calculated.

In this way, if the group designated as defensive driving by the designator 130 is excluded and the remaining group is designated as dangerous driving, the number of times each driver may be determined as dangerous driving is reduced.

The designator 130 may include a defensive driving threshold generator 132 that derives (e.g., set, determine, update, adjust, etc.) a threshold that may be classified as defensive driving based on the driving data of the group designated as a defensive driving group.

For example, the defensive driving threshold generator 132 may derive a threshold based on a statistical value of the driving data of the group designated as defensive driving if the distribution form of the driving data of the group designated as defensive driving exhibits normal distribution.

For example, the defensive driving threshold generator 132 may derive a threshold of an acceleration and deceleration rate of −10 kps/hs or less and a steering angle of 200 or more based on the statistical value of the driving data of the group designated as defensive driving.

The threshold may be utilized to extract driving data that may be determined as dangerous driving from the driving data received by the driving data receiver 112.

In addition, the defensive driving threshold generator 132 may derive the threshold by analyzing the driving data of a group designated as defensive driving using a machine learning algorithm.

The safety operation index calculator 140 calculates (e.g., updates, calibrates, recalibrates, etc.) a safety operation index for each driver based on the driving data of the remaining groups except the group designated as defensive driving.

For example, a driver's safety operation index may change from 75 to 85 before and after excluding the group designated as defensive driving.

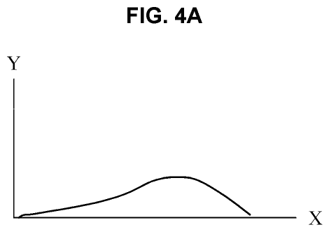

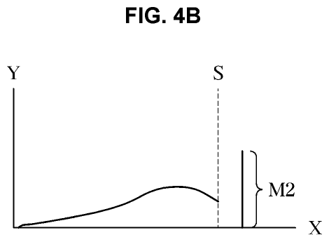

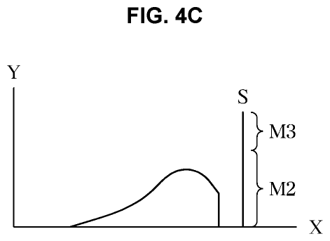

FIGS. 3 and 4 shows a process of calibrating a distribution map of a safety operation index calculated through the process of FIG. 2 by comparing it with a distribution map of a vehicle insurance accident compensation amount data.

It is necessary to verify the validity of the result of calculating the safe driving index for each driver based on the driving data of the remaining groups except the group designated as defensive driving among the plurality of groups after setting the parameter value (radius, minimum number of data) by the configurator 124 and grouping the data with the left value accordingly.

Referring to FIG. 3, for this purpose, the comparator 142 compares the distribution of the safe driving indexes by driver to the distribution of the vehicle insurance accident compensation data.

Then, based on the results of the above comparison, the corrector 144 changes one or more values of the radius and the minimum number of data so that the distribution of the safety operation index by driver is similar to the distribution of the automobile insurance accident damage data within a set range, so that the range designated as defensive driving is adjusted.

As shown in FIG. 3A, an automobile insurance claim data can be represented as a graph (hereinafter referred to as a Tweedie graph) and the automobile insurance claim data may have a distribution function with a long tail to the right.

In the Tweedie graph, the portion labeled M1 represents the number of drivers who have never had a vehicle accident with a zero insurance payout. The high payout cases represent a small fraction of the distribution, and the rest fall within a certain range of damages.

FIG. 3B shows an inverted Tweedie graph of FIG. 3A to compare vehicle insurance accident payout data to the distribution of the Safety operation index. The process of inverting the Tweedie graph may be performed by the comparator 142.

FIG. 4A is a graphical representation of the distribution of the safety operation index by driver calculated by the safety operation index calculation unit 140. Here, the x-axis is the safety operation index (0-100 points) and the y-axis is set as a ratio, e.g., if the total number of drivers is 50 and the score of 100 is 10, the y-value corresponding to 100 points is 0.2.

In FIG. 4B, the threshold S represents the safety operation index based on which the premium discount targets with zero insurance payouts are divided, and the portion labeled M2 is the sum of the number of drivers with safety operation indexes exceeding the threshold S, represented in the form of the Tweedie graph shown of FIG. 3B. This process may be performed by the comparator 142.

When M2 of FIG. 4B and M1 of FIG. 3B are compared with each other, they differ in the number of drivers (customers) with zero insurance payouts. Therefore, based on the comparison results, the corrector 144 changes one or more values of the radius and the minimum number of data so that the distribution of the safety operation index shows a similar shape to the distribution of the automobile insurance accident damage data within a set range.

For example, the corrector 144 resets the parameter values through the configurator 124 to change the radius R and the minimum number of data from 5 to 7 in order to expand the range designated as defensive driving. By doing so, the size of the data to be grouped by the grouper 120 is naturally adjusted, and the safety operation index calculator 140 calculates the safety operation index for each driver based on the driving data of the remaining groups except the group designated as defensive driving, so that the safety operation index may be increased overall.

Referring to FIG. 4C, it may be seen that the distribution graph of the safety operation index has been changed by the corrector 144 to resemble the Tweedie shape shown in FIG. 3B, and the number of drivers with zero insurance payouts has increased, as shown in the area labeled M3.

Although not shown, the above-described safety operation index calculator 100 may include a control unit that controls each component of the safety operation index calculator 100 and the means associated therewith. The control unit may include various processors and memory. All or part of the various components of the safety operation index calculator 100, as shown in FIG. 1, may be implemented with one or more processors and/or memory. The memory may store programs, instructions, applications, and the like for performing control. Each processor may execute a program, instruction, application, or the like stored in the memory. The control unit may include, for example, a control unit such as an electronic control unit (ECU) or a microcontroller unit (MCU).

Memory may include non-volatile memory elements such as cache, read only memory (ROM), programmable ROM (PROM), erasable programmable ROM (EPROM), electrically erasable programmable ROM (EEPROM), and flash memory. Memory may also include volatile memory elements such as random access memory (RAM) and storage media such as hard disk drives (HDDs) and CD-ROMs. Such memory may store information received by the safety operation index calculator 100 from an external device, results calculated by analyzing the data, settings, algorithms, and the like.

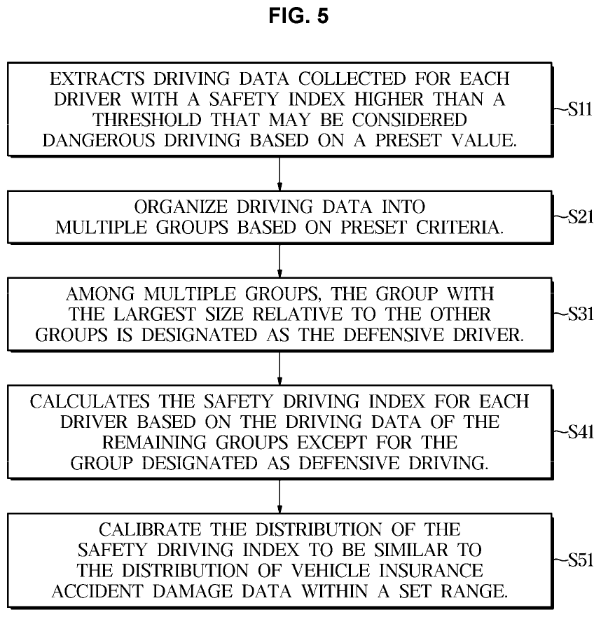

FIG. 5 shows a flowchart illustrating a method of calculating a safety operation index using the safety operation index calculation device shown in FIG. 1, and the specific details described in the safety operation index calculation device 100 are omitted as much as possible.

Referring to FIG. 5, the safety operation index calculation device extracts driving data that can be determined as dangerous driving from the driving data collected for each driver whose Safe Driving Index is higher than the reference value based on a preset value (S11).

This process (S11) may comprise receiving driving data including at least one of vehicle speed, steering angle, yaw rate, distance to a vehicle in front (e.g., a leading vehicle), lane change signal, road type, time of day, acceleration, sudden acceleration, sudden deceleration, sudden stop (e.g., coming to a complete stop at an acceleration that is above a threshold value), and sudden lane change (e.g., a lane change that takes place within a threshold amount of time) from a vehicle for each driver, and extracting driving data that exceeds or falls below the preset value as driving data that may be determined as dangerous driving.

Next, the safety operation index calculation device organizes (e.g., classifies, groups, etc.) the above-mentioned extracted driving data into a plurality of groups according to the set criteria (S21).

Specifically, this process (S21) may include representing each of the above-mentioned extracted driving data as data points with coordinate values, and if a minimum number (e.g., a predetermined minimum number) of data points exists within a preset radius centered on (e.g., a threshold distance away from) each of the data points, grouping the data points within the radius into one group.

Next, the safety operation index calculation device designates a group with a relatively larger size (e.g., the largest size) compared to the other groups as defensive driving among the plurality of groups (S31).

This process (S31) may be performed by designating a group with a relatively large number of data within the radius among the plurality of groups as a defensive operation, and designating the remaining groups as dangerous operations except for the group designated as a defensive operation.

And after this process (S31), the safety operation index calculation device may perform a process of deriving a reference value that can be classified as defensive driving based on the driving data of the group designated as defensive driving.

For example, in the process of deriving a threshold that may be classified as defensive driving, if the distribution form of the driving data of the group designated as defensive driving indicates (e.g., conforms to) a normal distribution form, the threshold may be derived based on the statistical value of the driving data.

As another example, in the process of deriving a threshold that may be classified as defensive driving, the threshold may be derived by analyzing the driving data of the group designated as defensive driving using a machine learning algorithm.

Next, the safety operation index calculation device calculates (e.g., sets, determines, updates, adjusts, etc.) the safe driving index for each driver based on the driving data of the remaining groups except for the group designated as defensive driving (S41).

The distribution of the safety operation index by driver is compared with the distribution of the vehicle insurance accident compensation data, and based on the comparison result, one or more values of the radius and the minimum number of data are changed so that the distribution of the safety operation index is similar to the distribution of the vehicle insurance accident damage data within a set range, and the range designated as defensive driving is adjusted (S51).

One or more example embodiments have been shown and described above. However, the disclosure is not limited to the above example embodiments, and those having ordinary knowledge in the technical field to which the disclosure belongs will be able to make various modifications without departing from the technical idea of the disclosure described in the following claims.

What is claimed is:

1. An apparatus comprising:
one or more processors; and
memory storing instructions that, when executed by the one or more processors, cause the apparatus to:
extract, from driving data collected for drivers whose safety operation indexes are higher than a threshold value, driving data that is determined as dangerous driving;
classify, based on predetermined criteria, the extracted driving data into a plurality of groups;
designate a group, of the plurality of groups, having a size larger than remaining groups of the plurality of groups, as a defensive driving group; and
update the safety operation indexes for the drivers based on at least a portion, of the extracted driving data, corresponding to the remaining groups.

2. The apparatus according to claim 1, wherein the extracted driving data comprises at least one of a vehicle speed, a steering angle, a yaw rate, a distance from a leading vehicle, a lane change signal, a road type, a driving time zone, an acceleration, a sudden acceleration, a sudden deceleration, a sudden stop, or a sudden lane change.

3. The apparatus according to claim 1, wherein, to classify the extracted driving data, the instructions, when executed by the one or more processors, cause the apparatus to:
convert each data point of the extracted driving data to coordinate values; and
create each group, of the plurality of groups, by selecting at least a predetermined minimum number of data points, of the extracted driving data, having coordinate values within a threshold distance away from each other.

4. The apparatus according to claim 1, wherein the instructions, when executed by the one or more processors, further cause the apparatus to designate the remaining groups, other than the defensive driving group, as a dangerous driving group.

5. The apparatus according to claim 1, wherein the instructions, when executed by the one or more processors, further cause the apparatus to adjust the threshold value based on at least a second portion, of the extracted driving data, corresponding to the defensive driving group.

6. The apparatus according to claim 3, wherein the instructions, when executed by the one or more processors, further cause the apparatus to:
compare a first distribution of the safety operation indexes of the drivers with a second distribution of motor vehicle insurance accident compensation data; and
adjust, based on a result of the comparison of the first distribution with the second distribution, at least one of the threshold distance or the predetermined minimum number of data points such that the first distribution is similar, within a predetermined range, to the second distribution.

7. A method comprising:
extracting, by an apparatus and from driving data collected for drivers whose safety operation indexes are higher than a threshold value, driving data that is determined as dangerous driving;
classifying, based on predetermined criteria, the extracted driving data into a plurality of groups;
designating a group, of the plurality of groups, having a size larger than remaining groups of the plurality of groups, as a defensive driving group; and
updating the safety operation indexes for the drivers based on at least a portion, of the extracted driving data, corresponding to the remaining groups.

8. The method according to claim 7, wherein the extracted driving data comprises at least one of a vehicle speed, a steering angle, a yaw rate, a distance from a leading vehicle, a lane change signal, a road type, a driving time zone, an acceleration, a sudden acceleration, a sudden deceleration, a sudden stop, or a sudden lane change.

9. The method according to claim 7, wherein the classifying comprises:
converting each data point of the extracted driving data to coordinate values; and
creating each group, of the plurality of groups, by selecting at least a predetermined minimum number of data points, of the extracted driving data, having coordinate values within a threshold distance away from each other.

10. The method according to claim 7, further comprising designating the remaining groups, other than the defensive driving group, as a dangerous driving group.

11. The method according to claim 7, further comprising adjusting the threshold value based on at least a second portion, of the extracted driving data, corresponding to the defensive driving group.

12. The method according to claim 11, further comprising adjusting, based on the at least second portion of the extracted driving data conforming to a normal distribution, the threshold value.

13. The method according to claim 11, further comprising adjusting, based on the at least second portion of the extracted driving data, the threshold value using a machine learning algorithm.

14. The method according to claim 9, further comprising:
comparing a first distribution of the safety operation indexes of the drivers with a second distribution of motor vehicle insurance accident compensation data; and
adjusting, based on a results of the comparison of the first distribution with the second distribution, at least one of the threshold distance or the predetermined minimum number of data points such that the first distribution is similar, within a predetermined range, to the second distribution.
